(19) United States
(12) Patent Application Publication
(10) Pub. No.: US 2010/0052561 A1
(43) Pub. Date: Mar. 4, 2010

(54) METHOD FOR DRIVING AN INVERTER OF A GAS DISCHARGE SUPPLY CIRCUIT

(75) Inventor: Peter Luerkens, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,042

(22) PCT Filed: Jun. 21, 2006
(86) PCT No.: PCT/IB06/52004

§ 371 Date: Dec. 19, 2007

(30) Foreign Application Priority Data
Jun. 21, 2005 (EP) 05105479.9

(51) Int. Cl. H05B 41/36

(52) U.S. Cl. 315/291

(57) ABSTRACT

A method of controlling an inverter (4) of a gas discharge lamp circuit. The inverter comprises two branches, each having a first semiconductor switch (32, 36) in series with a second semiconductor switch (34, 38) and having a connection node (40, 44), which is connected to a respective output terminal (42, 46) of the inverter. The first and second switches are connected to a first input terminal (16) and to a second input terminal (18) of the inverter, respectively. Each switch has an intrinsic or externally connected antiparallel diode (52-56). The switches of the branches are controlled by a controller in an alternating and cross-like manner to conduct and to not conduct. Controlling of switches is delayed by a first delay time per branch and by a second delay time between branches.

### FIELD OF THE INVENTION

The invention relates to a method for driving an inverter of a gas discharge supply circuit as described in the preamble of claim 1.

### BACKGROUND OF THE INVENTION

U.S. Pat. No. 6,815,910 discloses a device for operating a high pressure discharge lamp, in which a DC voltage supply supplies an inverter, which comprises a smoothing capacitor at its DC input and four switches connected to each other as a full-bridge, and in which the inverter supplies the lamp through a series inductor at its output Said inductor will store energy, such that a current, yet decaying, will be kept flowing through the lamp during a dead time. To some extent this will prevent the occurrence of an undesirable perceptible darkening for a moment during the dead time. A dead time prevents basically short-circuiting of the DC supply, because the switches tend to have some delay which can lead to an overlapping conduction of two switches in series. The switches are semiconductor switches, which may be FETs. To each switch there is connected a diode antiparallel.

It is noted that if the switches of the inverter are MOSFETs there is an intrinsic diode of each switch being connected antiparallel.

The inverter provides a rectangular AC output voltage. From each transition of the output voltage of the inverter the inductor, tends to maintain a current through it flowing. As a consequence, said current commutates from flowing through one pair of switches to flow through diodes, possible intrinsic diodes, associated with the other switches. As a result the output voltage of the inverter will reverse. The inverter output voltage will then be identical to that when said other switches are turned on to conduct from the end of the dead time, while the current in the lamp quickly decays. In some cases, when the current has become too low the lamp will extinguish, in particular if the current reverses slowly, i.e. in a time frame of several microseconds, ore more. This will happen because the ignition transformer, necessary for starting the lamp, has typically such a high inductance, that current reversal will not occur in a time frame, short enough to avoid temporarily extinguishment. This means that the conductivity of the discharge path in the lamp decreases to a very low value, and needs to be re-established with some extra voltage being significantly higher than the burning voltage of the lamp before commutation.

Usually, this is produced by some voltage overshoot, occurring during turn on of the inverter switches after the dead-time has elapsed. The voltage overshoot is generated by the voltage step of the turn-on of the power transistors and a resonance circuit, formed by the inductor in the lamp igniter and some parasitic capacitor across the lamp.

Some igniters, however, namely steel-shielded versions, have an unfavorable dynamic behavior during commutation, leading to compensation currents in the igniter, which counteract the voltage overshoot. In this case, the extra voltage is no longer sufficient to re-ignite the lamp after commutation. The effect is, that even after the dead-time has elapsed, the lamp current does not return, but a much longer time is needed until the current source in the lamp driver has build up enough voltage. This may lead to flickering and even to extinguishing of the lamp.

### OBJECT OF THE INVENTION

It is an object of the invention to solve the drawbacks of the prior art as described above.

### SUMMARY OF THE INVENTION

The above object of the invention is achieved by providing a method as described in claim 1.

Accordingly, by time shifting the control patterns for turning on and off of switches of the inverter with respect to the prior art, sufficient time is given for the eddy currents occurring in a shielding of an igniter part to decay, after which the commutation can be continued, leading to a sufficient re-ignition voltage. As a result flickering and unwanted extinguishing of the lamp is avoided.

### BRIEF DESCRIPTION OF THE DRAWINGS

The invention will become more gradually apparent from the following exemplary description in connection with the accompanying drawing. In the drawing:

FIG. 1 shows a diagram of a prior art a gas discharge lamp circuit, which is suitable for applying the method according to the invention;

FIGS. 2A-2G show a prior art time pattern of control signals to inverter switches and inverter output voltages for each inverter output terminal with respect to zero and with respect to each other respectively; and

FIGS. 3A-3G show a time pattern according to the invention of signals and voltages corresponding to those of FIGS. 2A-2G, respectively.

### DETAILED DESCRIPTION OF EXAMPLES

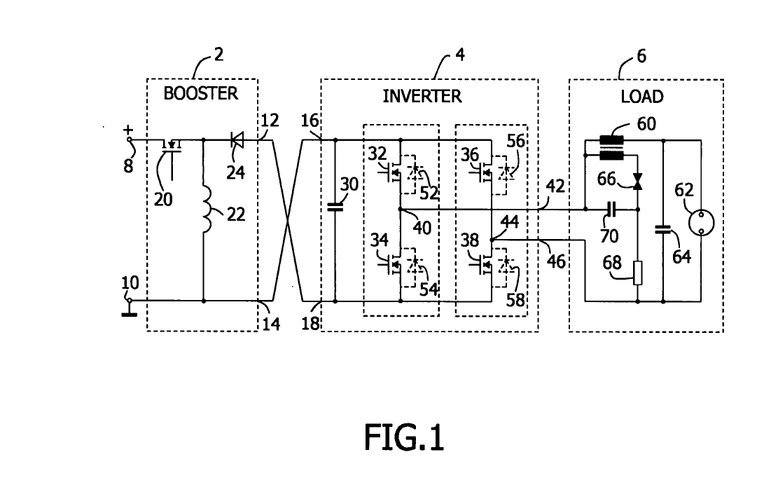

FIG. 1 shows a diagram of a prior art gas discharge lamp circuit. In particular the lamp is a xenon lamp and the circuit is used in a car. The circuit comprises a booster 2, an inverter 4 and a load 6.

The booster 2 has input terminals 8 and 10 for connection to a direct current (DC) power supply source (not shown) and DC output terminals 12 and 14 for connection to DC input terminals 16 and 18 of the inverter 4, respectively. The DC power supply source can be a car battery. A switch 20, which is in particular a semiconductor switch, and an inductor 22 of the booster 2 are connected in series to said DC input terminals 8 and 10. A node of the switch 20 and the inductor 22 is connected to a DC output terminal 12 of the booster 2 via a diode 24. The other DC output terminal 14 is connected to DC input terminal 10. As indicated in FIG. 1, if DC input terminal 8 is connected to a positive voltage of the DC supply source and DC input terminal 10 is at zero or mass voltage, the anode of the diode 24 is connected to DC output terminal 12. A controller (not shown) controls the switch 20 to alternately conduct and to not conduct.

When switch 20 is controlled to conduct a current will flow from DC input terminal 8 and via switch 20 and inductor 22 to DC input terminal 10. When switch 20 is then controlled to not conduct the inductor 22 tends to maintain the current flowing through it. As a consequence the current through the inductor 22 will be drawn through the diode 24. As a result the booster 2 will supply a DC output voltage, such that a voltage at DC output terminal 12 will be negative with respect to DC output terminal 14. A magnitude of the DC output voltage at DC output terminals 12 and 14 depends on a load connected to it. With the example for use with a xenon lamp in a car the booster 2 is designed to supply a DC voltage of about 90V during steady-state operation.

The inverter 4 comprises a smoothing capacitor 30, which is connected to the DC input terminals 16 and 18 of the inverter 4. The inverter 4 also comprises a bridge-like arrangement of semiconductor switches. A first branch of the switch arrangement comprises, in series, a first switch 32 and a second switch 34. A second branch of the switch arrangement comprises, in series, a first switch 36 and a second switch 38. The first switches 32, 36 are connected to a first DC input terminal 16 of the inverter 4 and the second switches 34, 38 are connected to a second DC input terminal 18 of the inverter 4. A connection node 40 of switches 32 and 34 of the first branch is connected to a first output terminal 42 of the inverter 4. A connection node 44 of switches 36 and 38 of the second branch is connected to a second output terminal 46 of the inverter 4.

As indicated switches 32, 34, 36 and 38 are MOSFET switches. Each of them has an intrinsic (bulk to drain) diode 52, 54, 56 and 58, respectively, which is shown by dashed lines. Instead of MOSFET switches other semiconductor switches, such as bipolar transistors, may be used and a diode may be connected antiparallel to the switch to sustain a current flowing through an inductor of the load 6, as will be described later.

A controller (not shown) is connected to control inputs (gates) of the switches 32, 34, 36 and 38 to control switches 32, 34, 36 and 38 in an alternating and cross-like manner. Basically, according to prior art, this means that the controller controls the switches such that when a first switch 32 or 36 of one branch is controlled to conduct a second switch 38 or 34, respectively, of the other branch is controlled to conduct also, while the other switches are controlled to not conduct. After some time the control of the switches for conducting and not conducting is reversed, and so on. As a result, an output voltage having a rectangular waveform is provided at the output terminals 42 and 46 of the inverter 4. More specifically, the controller delays controlling of the switches per branch by a first delay time, which is known as dead time, to prevent that both switches of a branch conduct at the same time, which could lead to a destroy of the switches by a short cut current flowing from DC input terminal 16 to DC input terminal 18.

The load 6 is connected to the output terminals 42 and 46 of the inverter 4. The load 6 comprises an ignition transformer 60, of which a first or primary winding is connected in series with a gas discharge lamp 62 to the output terminals 42 and 46 of the inverter 4. The lamp may be a xenon lamp. A capacitor 64 denotes a parasitic capacitance over the transformer 60 and the lamp 62. A second or secondary winding of the transformer 60 is connected in series, in this order, with a spark gap 66 and a charging resistor 68 to the output terminals 42 and 46 of the inverter 4. An ignition capacitor 70 is connected in parallel to the series of the secondary winding of the ignition transformer 60 and the spark gap 66. The mechanism of the ignition is not relevant for an operation of the circuit according to the invention. Therefore, a detailed description of said mechanism is omitted here.

A lamp of a type as indicated above must be supplied with a current of alternating polarity. As a consequence, with each transition of polarity the output voltage of the inverter 4 the lamp 62 must be re-ignited. The load 6 may provide a resonant boost of a voltage at the lamp 62 at each of said transitions which may be sufficient to re-ignite the lamp 62. However, the inventors found that the occurrence of eddy currents in a metal shielding of an igniting part of the lamp 62 can suppress effectively the generation of sufficient overvoltage. Said eddy currents counteract the resonant alternation of the lamp voltage, which may lead to not re-igniting of the lamp 62, visible flickering of radiant light and even to permanent extinguishing of the lamp 62.

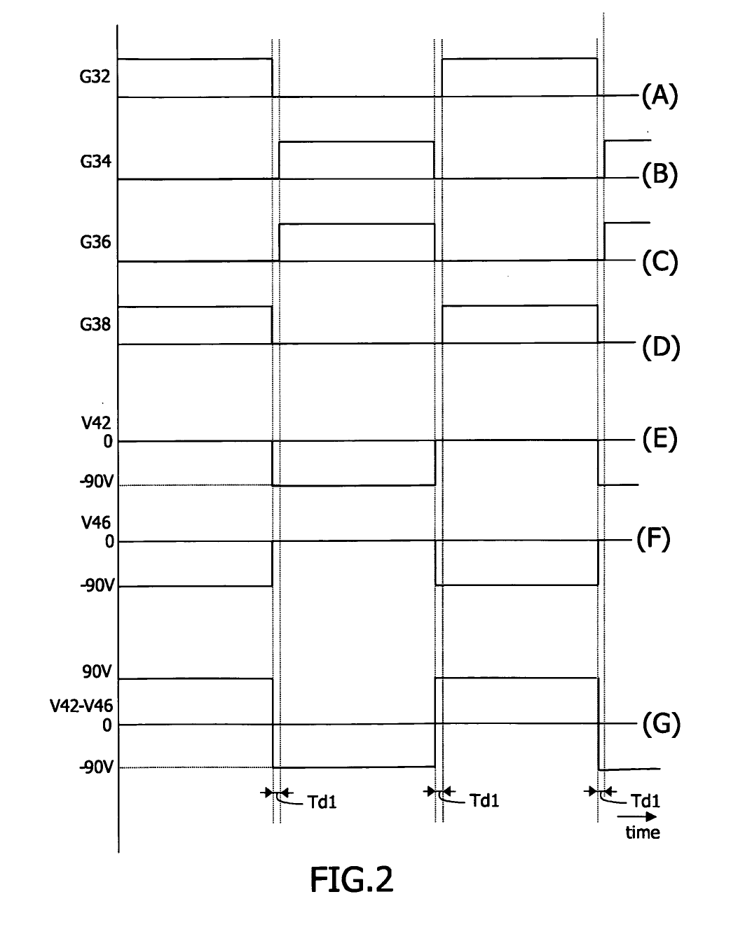

According to the invention the disadvantage of reduced overvoltage is solved by applying an improved control scheme (or pattern) for controlling the switches 32, 34, 36 and 38. The improved scheme will be described while referring to the present, prior art control scheme illustrated by FIG. 2 first.

The diagram of FIG. 2 shows four control signals G32, G34, G36 and G38, which have logical levels and which are supplied by the controller (not shown), mentioned above, to control inputs, in particular gates, of the switches 32, 34, 36 and 38, respectively. A high level of each of the control signals G32, G34, G36 and G38 indicates that the switch to which it is supplied is controlled to conduct. A low level (zero) indicates that the switch is controlled to not conduct.

According to the prior art scheme shown in FIG. 2, switches 32 and 38 are controlled simultaneously to both conduct or to not conduct. The same applies for switches 34 and 36. Periods of controlling to conduct are alternated by periods to not conduct. Upon controlling switches 32 and 38 to not conduct a time out of a delay Td1 is started. During the delay Td1 all switches 32, 34, 36 and 38 are controlled to not conduct. Therefore this delay time Td1 is called “dead time”. Upon time out of the delay time Td1 the other switches 34 and 36 are controlled to conduct. Similarly, upon turning off switches 34 and 36 a delay Td1 is introduced also before turning on switches 32 and 38. The delay time Td1 is introduced to prevent the occurrence of a short circuit between the DC input terminals 16 and 18.

In FIG. 2 voltages at output terminals 42 and 46 with respect to zero are indicated by V42 and V46 respectively. As mentioned above, for the present example said voltages are 0V or −90V. An output voltage of the inverter 4 equals the difference between the voltages at inverter outputs 42 and 46, which is indicated by V42-V46 in FIG. 2.

When switches 32 and 38 are conducting output terminal 42 is connected to DC input terminal 16 and output terminal 46 is connected to DC input terminal 18, so that V42=0 and V46=−90V. At this time a current will flow from DC input terminal 16 through switch 32, load 6 and switch 38 to DC input terminal 18. Upon turning off switches 32 and 38 the first winding of transformer 60 of the load 6 tends to maintain a current to flow through it. As a result the current through the inverter 4 commutates from a path through switches 32 and 38 to a reverse inverter path through diodes 54 and 56 of the other switches 34 and 36, respectively, V42 and V46 reverse values and inverter output voltage V42-V46 reverses polarity. This situation, of a current flowing through diodes 54 and 56, may last some time, possibly for the delay time Td1. At the end of the delay time Td1 this current may not be zero, which may lead to a resonant rise of a voltage across the lamp 62 which is insufficient to re-ignite, which will lead to flickering and possibly to extinguishing of the lamp 62 completely. The resonant rise of the lamp voltage is counteracted also because of the occurrence of eddy currents in a metal shielding of an igniter part of the load 6.

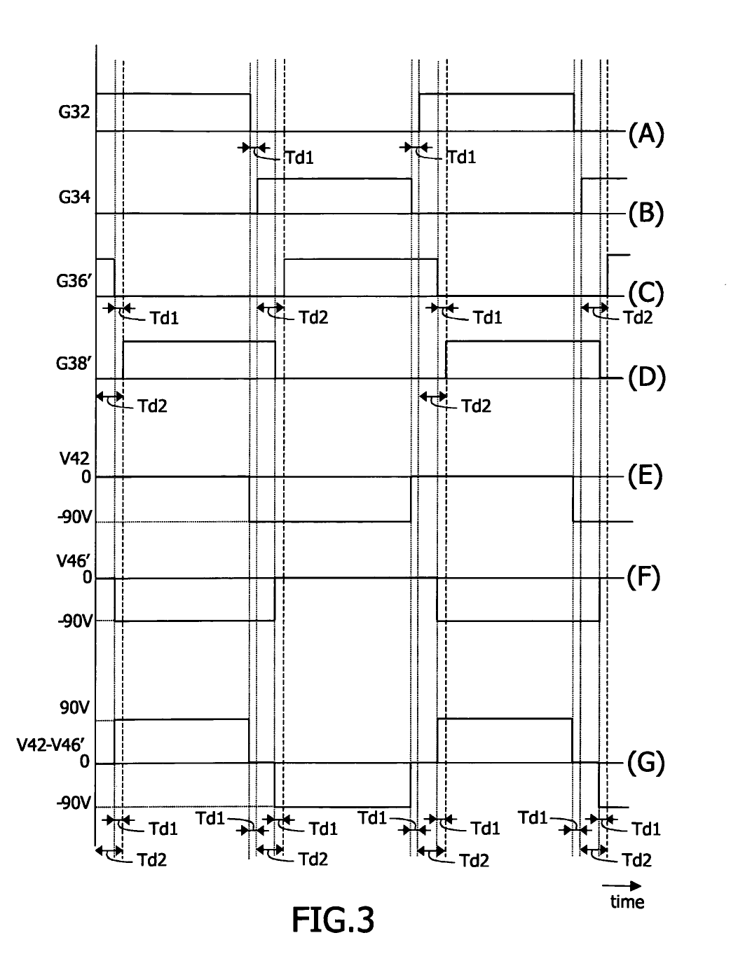

According to the invention an improved scheme or pattern for controlling the switches 32, 34, 36 and 38 is provided, as illustrated by FIG. 3. FIG. 3 shows voltages as function of time at the same locations as described with reference to FIG. 2. Control signals G32 and G34 and voltage V42 are identical in both FIG. 2 and FIG. 3. The other control signals and voltages are different in FIGS. 2 and 3. Therefore, in FIG. 3 control signals G36 and G38 and voltage V46 have been replaced by G34′, G38′and V46′. Accordingly, the output voltage between the output terminals 42 and 46 of the inverter 4 has become V42-V46′.

As indicated by FIG. 3, according to the invention, controlling of the branch of switches 36 and 38 is delayed by a second delay time Td2 with respect to a turning on transition of the switches 32 and 34 of the other branch. That is, switch 38 is not turned on and off simultaneously with switch 32, as is the prior art case, but after said second delay time Td2. The same applies for the controlling of switch 36 with respect to switch 34.

Because of the introduction of the second time delay Td2 the voltage V46′ at output terminal 46 is shifted in time also with respect to the prior art case of FIG. 2. As a result the inverter output voltage V42-V46′ will contain an interval, following a tuning off of either switch 32 and 34, during which it is zero. Because of the occurrence of such zero intervals in the inverter output voltage the resonant rise of the lamp voltage is made sufficiently high to let the lamp 62 re-ignite at the end of the second delay time Td2.

Preferably, the second delay time Td2 is longer than the first delay time Td1. Preferably also, the second delay time has a duration in a range of 20 to 40 microseconds. This is useful in particular for automotive applications.

1. A method of controlling an inverter of a gas discharge lamp circuit, the inverter having two input terminals for connecting the inverter to a direct current voltage supply source, two output terminals for connecting to a load, which comprises in series an inductor and gas discharge lamp, the inverter further comprising two branches of semiconductor switches, each branch comprising a first switch and a second switch, which are connected to each other at a connection node and to a first input terminal and to a second input terminal, respectively, said nodes being connected to the output terminals, whereby with each switch there is a diode antiparallel to the switch, and the switches being controlled by a controller, such that the first switch of one branch and the second switch of the other branch are controlled to conduct and to not conduct in an alternating manner with respect to the other switches, and for each branch the controlling of a switch to conduct is delayed by a first delay time from the time the other switch of the branch is controlled to not conduct, characterized in that, from the controlling of the first and second switch of one branch the controlling of the switches of the other branch is delayed by a second delay time, such that an output voltage between the output terminals will be zero during part of the second delay time.

2. Method according to claim 1, characterized in that, the second delay time is longer than the first delay time.

3. Method according to claim 1, characterized in that the second delay time has a duration in a range of 20 to 40 microseconds.

4. A circuit arrangement for operating a gas discharge lamp comprising an inverter of the full bridge type, the inverter having two input terminals for connecting the inverter to a direct current voltage supply source, two output terminals for connecting to a load, which comprises in series an inductor and connection terminals for connecting a gas discharge lamp, the inverter further comprising two branches of semiconductor switches, each branch comprising a first switch and a second switch, which are connected to each other at a connection node and to a first input terminal and to a second input terminal, respectively, said nodes being connected to the output terminals, whereby with each switch there is a diode antiparallel to the switch, and a controller for controlling the switches, such that the first switch of one branch and the second switch of the other branch are controlled to conduct and to not conduct in an alternating manner with respect to the other switches, and for each branch the controlling of a switch to conduct is delayed by a first delay time from the time the other switch of the branch is controlled to not conduct, characterized in that the controller is equipped with means for delaying the controlling of the first and second switch of one branch with respect to the controlling of the switches of the other branch by a second delay time, such that an output voltage between the output terminals will be zero during part of the second delay time.

5. Circuit arrangement according to claim 4, characterized in that the second delay time is longer than the first delay time.

6. Circuit arrangement according to claim 4, characterized in that the second delay time has a duration in a range of 20 to 40 microseconds.
